(19) United States
(12) Patent Application Publication
(10) Pub. No.: US 2014/0044473 A1
(43) Pub. Date: Feb. 13, 2014

(54) ROTARY SHAFT LOCATION STRUCTURE

(71) Applicants: AN SZU HSU, NEW TAIPEI CITY (TW); YUNG SHENG KUO, NEW TAIPEI CITY (TW)

(72) Inventors: AN SZU HSU, NEW TAIPEI CITY (TW); YUNG SHENG KUO, NEW TAIPEI CITY (TW)

(73) Assignee: FIRST DOME CORPORATION, NEW TAIPEI CITY (TW)

(21) Appl. No.: 13/568,430

(22) Filed: Aug. 7, 2012

(51) Int. Cl. F16C 11/04

(52) U.S. Cl. 403/120

(57) ABSTRACT

A rotary shaft location structure is utilized to improve conditions of complicated, inconvenient, time-consuming and troublesome installation of conventional locating components, based. on a compact request. The rotary shaft includes a combination of a shaft body and a cylinder body, in which the cylinder body includes a rigid wall and a chamber defined by the rigid wall and utilized to receive the shaft body. The shaft body includes at least one arc region and a plane region, at least one elastic device is installed inside the chamber of the cylinder body to form a contact or interference condition with the shaft body, and the elastic device and the shaft body generate a frictional resistance in response to a movement of the shaft body, thereby improving conditions such as easy-to-produce deformation and abrasion in conventional locating components.

### BACKGROUND OF THE INVENTION

1. Field of the Invention

The invention relates to a rotary shaft structure applied in an electronic apparatus, in particular relates to a rotary shaft location structure capable of improving conditions such as abrasion and deformation stress in conventional locating components by applying a locating function of fictional resistance generated from a variable diameter of a rotary shaft together with an elastic device so as to acquire efficacy of assembling simplicity.

2. Description of the Related Art

Rotary shafts (or pivot shafts), which are capable of being reciprocally freely rotated by an external force to be assembled on electric apparatuses (e.g., mobile phones. notebook computers, vehicle traveling data recorders a Id digital image capturing devices, etc.) to rotatable open and dose covers and display screens thereof, are generally known as conventional skills. Some typical cases provide combinations of the rotary shafts and the locating components (locating modules).

One topic related to operations, motions and structural designs above-described cases shall be concerned is that, based on embedded structures such as locating flanges, convex pockets or concavo-convex locating portions which are disposed on relative planes of washers, elastic plates or elastic members, friction plates or related components, the flange is formed with locating function in the rotation operation of the rotary shaft when he flange is rotated to the position of the convex pocket. However after an operation period, the locating effects of these flanges, convex pockets or concavo-convex locating portions applied on relative fitting planes of electronic products are soon inconsiderable due to abrasion constantly generated by rigid contacts.

As to the combination of the multiple washers and friction plates, together with in cooperation with energy storage and release of elastic rings or springs to attain rotational and locating functions of the rotary shaft or pivot shaft component applied in conventional skills, it will be understood by those who skilled in these arts in that the whole structural design and assembly fitting become more complicated, and an assembled arrangement length of the whole structure in an axial direction is greatly increased, thus to impair and limit the arrangement spaces of the rotary shaft and the electronic apparatus.

Another topic related to assembly and fitting of the rotary shaft and the locating component is that the elastic clamping function or the three regulation of frictional resistance is acquired by operating the lock-packing degree of the screw nut. If the packed washer is too slack, the rotary shaft (or the cover, display screen) cannot have an ideal locating effect. However, if the packed washer is too tight, the washer is regularly formed with stress and deformation, and abrasions are particularly formed between the fitted components to cause unstableness and slackness of the rotary shaft after the rotary shaft is operated.

Therefore, it is relatively inconvenient and difficult to adjust the screw nut to pack the washer by an assembling fitter for obtaining an ideal elastic clamping function or frictional resistance. In practice, the washer is often deformedly destroyed and therefore the condition of non-uniform elasticity or unequal resistance is generated from the elastic clamping function or frictional resistance in the operation process of the rotary shaft. It is not only to form the rotary shall as a defect product but also to increase the manufacturing cost; however, these conditions are not our expectations.

Representatively speaking, these reference data reveal the conditions of usage and structural design of the rotary shaft, the locating component or components connected therewith. If the structure and the above-described applications of the rotary shaft and components connected therewith can be properly and reconsidered, the use pattern and the application conditions of the rotary shaft can be advancedly altered and therefore distinguished from conventional methods, and it is actually not only can improve conditions such as easy-to-produce stress and deformation destructions or abrasion on the fitted components, but also can increase; the assembling convenience. For example, based on the structural design of the rotary shaft capable of satisfying without increasing fitting difficult and requirements of the assembled locating components, an adjusting mechanism of elastic clamping function or frictional resistance of the location structure can be obtained in accordance with the diameter variation of the rotary shaft or a structure different from conventional one can be provided to improve the condition of non-uniform elasticity or unequal resistance generated in the operation process of the rotary shaft in conventional methods.

However, these topics are not taught or disclosed in the above-mentioned reference data.

### BRIEF SUMMARY OF THE INVENTION

In view of this, the main purpose of the invention is to provide a rotary shaft location structure for ii improving conditions of complicated, inconvenient, time-consuming and troublesome installation of conventional locating components, based on a compact request. The rotary shaft includes a combination of a shaft body and a cylinder body, in which the cylinder body includes a rigid wall and a chamber defined by the rigid wall and utilized to receive the shaft body. The shaft body includes at least one arc region and a plane region gat least one elastic device is installed inside the chamber of the cylinder body to form a contact or interference condition with the shaft body, and the elastic device and the shaft body generate a frictional resistance in response to a movement of the shaft body, thereby improving conditions such as easy-to-produce deformation and abrasion in conventional locating components.

According to the rotary shaft location structure of the invention, the elastic device comprises a load portion and an arm portion, and the elastic device is an elastic sheet formed by type of a hexagonal-bracket shape. The load portion of the elastic device and the shaft body are formed in a contact or interference state, and the arm portion of the elastic device is supported by the rigid mall of the cylinder body. Therefore, when the shaft body is a rotated, the shaft body and the load portion of the elastic device generate a frictional resistance, thereby forming a locating function.

According to the rotary shaft location structure of the invention, the arc region and the plane region are formed on a surface of the shaft body, and the plane region of the shaft body comprises a first plane region and a second plane region, in which the first plane region and the second plane region are configured by type of an interval of 180 degrees.

A detailed description is given in the following embodiments with reference to the accompanying drawings.

### BRIEF DESCRIPTION OF THE. DRAWINGS

The invention can be more fully understood by reading it e subsequent detailed description and examples with references made to the accompanying drawings, wherein:

FIG. 1 is a schematic view of an outlook structure of the invention;

FIG. 2 is an exploded schematic view of the structure of FIG. 1;

FIG. 3 is a sectional schematic view of the three-dimensional structure of FIG. 1, showing an assembly condition of as shaft body, a cylinder body and an elastic device;

FIG. 4 is a sectional schematic view of a structure of the invention, depicting a condition of a load portion of an elastic device to be pressed on a plane region of a shaft body;

FIG. 5 is a schematic view of an operative embodiment of the invention, showing a condition of a load portion of an elastic device to be pressed on an arc region of a shaft body as the shaft body is rotated; and

FIG. 6 is a schematic view of a modified embodiment of the invention, depicting a condition of a shaft body and a head portion which are formed by integral type.

### DETAILED DESCRIPTION OF THE INVENTION

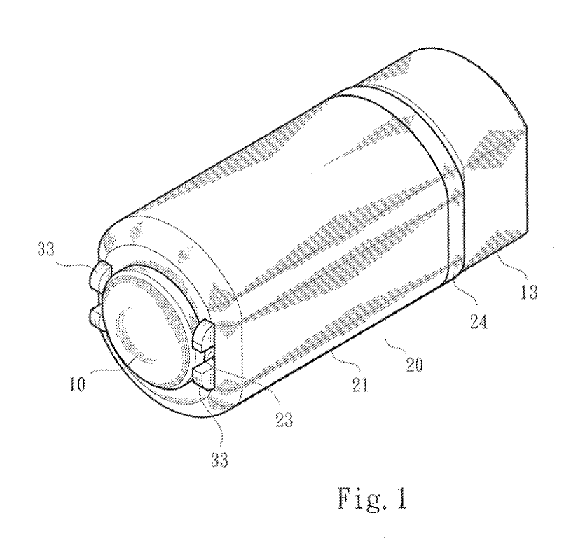

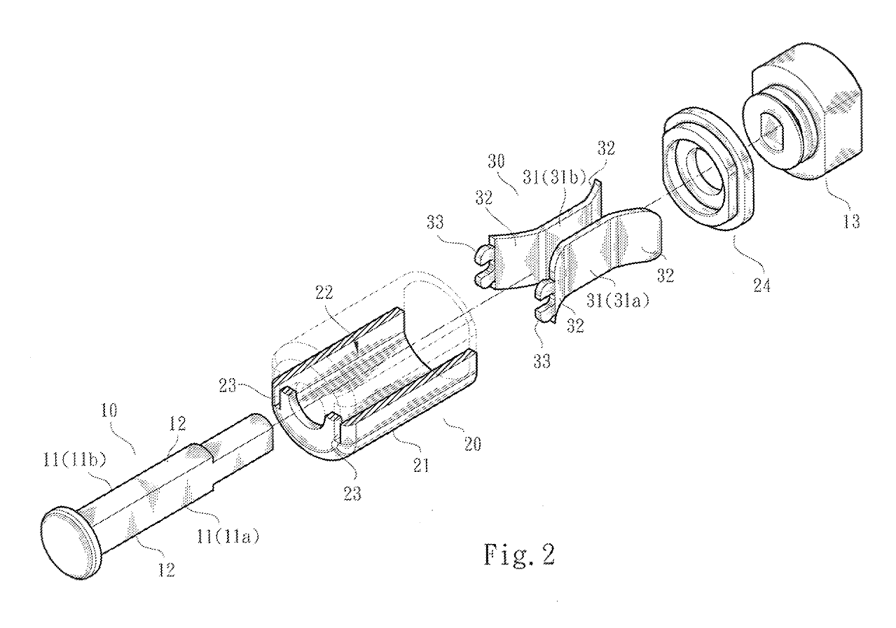

Referring to FIGS. 1, 2 and 3, a rotary shaft location structure of the invention comprises a combination of a shaft body and a cylinder body, in which the shall, body and the cylinder body are generally denoted by reference numbers 10 and 20, respectively. The shaft body 10 and the cylinder body 20 are assembled on an electronic apparatus (e.g., a mobile phone, a notebook computer, a vehicle traveling data recorder, digital image-capturing devices, etc, but not shown in FIGS.), so that a cover or a display screen of the electronic apparatus can be rotatably opened or closed.

In these figures, it is showed that the shaft body 10 formed by type of a cylindrical body is pivoted to a head portion 13. The shaft body 10 comprises a plane region 11 and at least one arc region 12, in which the arc region 12 and the plane region 11 are formed on a surface of the shaft body 10. In an adopted embodiment, the plane region 11 of the shaft body 10 comprises a first plane region 11a and a second plane region 11b, in which the first plane region 11a and the second plane region 11b are configured by type of an interval of 180 degrees.

In FIGS. 1, 2 and 3, it is also depicted that the cylinder body 20 comprises a rigid wall 21 and a chamber 22 defined by the rigid wall 21 and utilized to receive the shaft body 10. Moreover, at least one elastic device 30 is installed inside the chamber 22 of the cylinder body 20 to term a contact or an interference condition with the shaft body 10, and the elastic device 30 and the shaft body 10 generate a frictional resistance in response to a movement of the shaft body 10.

In the adopted embodiment, the elastic device 30 comprises a load portion 31 and an arm portion 32. The elastic device 30 is an elastic sheet formed by type of a hexagonal-bracket shape, so that the elastic device 30 is provided with one load portion 31 and two arm portions 32 in the figures. The load portion 31 of the elastic device 30 and the shaft body 10 are formed in a contact or interference state, and the arm portion 32 of the elastic device 30 is supported by the rigid wall of the cylinder body 20. Therefore, when the shaft body 10 is rotated, the shaft body 10 and the load portion 31 of the elastic device 30 generate a frictional resistance, thereby forming a locating function.

Specifically, the elastic device 30 comprises at least one end (i.e., a tail end of one arm portion 32) provided with an extended portion 33 Which is formed by type of a similar claw-shaped. Object to embed on the cylinder body 20 in the adopted embodiment, the cylinder body 20 further comprises a slit 23 assembled with the extended portion 33 of the elastic device 30, so that the elastic device 30 is fixed inside the chamber 22 of the cylinder body 20.

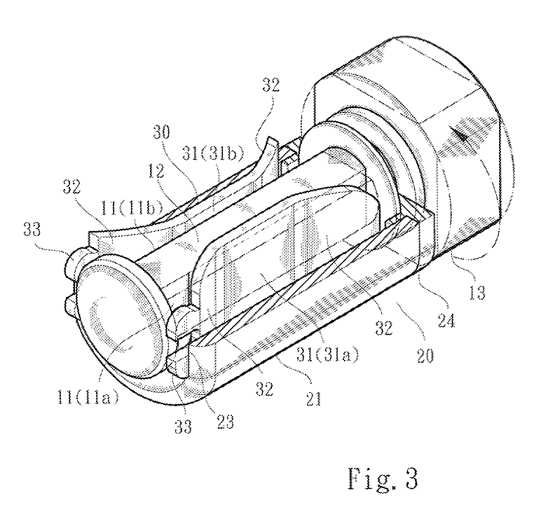

FIG. 3 depicts that the cylinder body 20 further comprises as cover 24 utilized to seal the chamber 22 of the cylinder body 20, and the shaft body 10 is pivoted to the head portion 13 so that the head portion 13 is located outside the cylinder body 20. Besides, the cover 24 of the cylinder body 20 is also utilized to limit the shaft body 10 and the head portion 13 to prevent slackness.

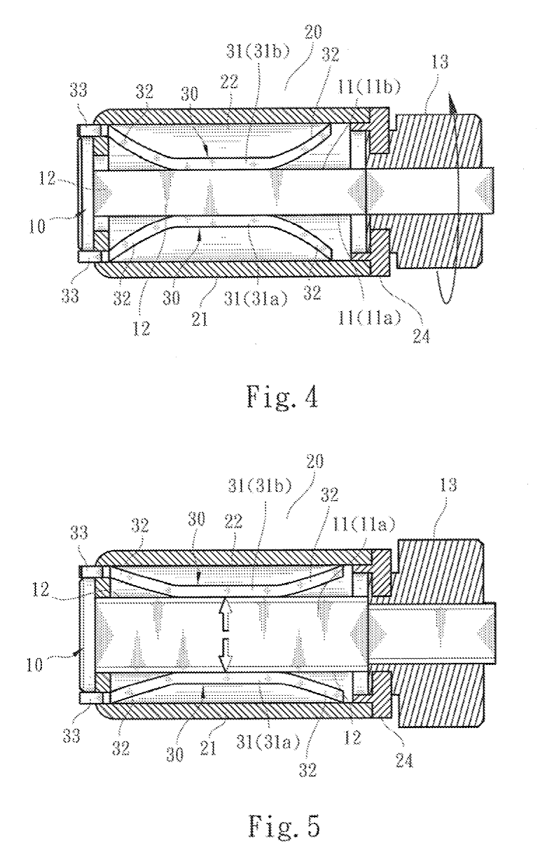

FIG. 3 also depicts an assembly condition of the shaft body 10, the cylinder body 20 and the elastic device 30. The shaft body 10 is assembled in the chamber 22 of the cylinder body 20, and two elastic devices 30 are assembled in the chamber 22 of the cylinder body 20, so that the two elastic devices 30 are utilized to press on the first plane region 11a. and the second plane region 11b of the shaft body respectively. For the convenience of description, the load portions of the elastic devices 30 to be pressed on the first plane region 11a and the second plane region 11b of the shall body 10 are denoted by reference numeral 31a and 31b, respectively. Therefore, in an initial assembly position, the load portion 31a of the elastic device 30 and the first plane region 11a of the shaft body 10 are formed as a contact or an interference condition, and the load portion 31b of the elastic device 30 and the second plane region 11b of the shaft body 10 are formed as a contact or an interference condition, as the condition shown in FIG. 4.

It is needed to explain that, with a clamping force generated from the elastic devices 30 to be pressed on the first plane region 11a and the second plane region 11b of the shaft body 10, the shaft body 10 and the head portion 13 do not rotate. Moreover, in the initial assembly position, it is presumed that the cover or the display screen of the electronic apparatus is located at a closed position.

Referring to FIG. 4, when a user operates the cover or the display screen of the electronic apparatus to motion from the closed position toward an opening or opened position, the shaft body 10 and the head portion 13 are driven to rotate, thereby driving the first plane region 11a and the second plane region 11b of the shaft body 10 to leave the load portion 31 (or the load portions 31a and 31b) of the elastic device 30 and driving the load portions 31a and 31b of the elastic device 30 to relatively move toward the arc region 12 of the shaft body 10. The elastic device 30 is gradually pressed by the arc region 12 of the shall body 10 with respect to the rotation of the shaft body 10, thereby driving the elastic device 30 and the shaft body 10 to generate a frictional resistance (or rotational torsion) capable of immediately locating the cover or the display screen of the electronic apparatus.

Due to a distance (or a radius) measured from the arc region 12 of the shaft body 10 to a center of the shaft body 10 being greater than a distance measured from the first plane region 11a or the second plane region 11b) of the shaft body 10 to the center of the shall body 10, when the shaft body 10 is rotated to a position shown in FIG. 5, the elastic device 30 and the shaft body 10 can form a maximum frictional resistance to cause the elastic device 30 to generate a maximum clamping force. If the cover or the display screen of the electronic apparatus is continuously rotated to cause the shaft body 10 for continuous rotation, the load portion 31b of the elastic device 30 is pressed on the first plane region 11a of the shaft body 10, and the load portion 31a of the elastic device 30 is pressed on the second plane region 11b of the shaft body 10. Therefore, the clamping force of the elastic device 30 which is pressed on the first plane region 11a and the second plane region 11b of the shaft body 10 causes the shaft body 10 and the head portion 13 not to rotate again. At this moment, the cover or the display screen of the electronic apparatus is situated at an (fully) opened position.

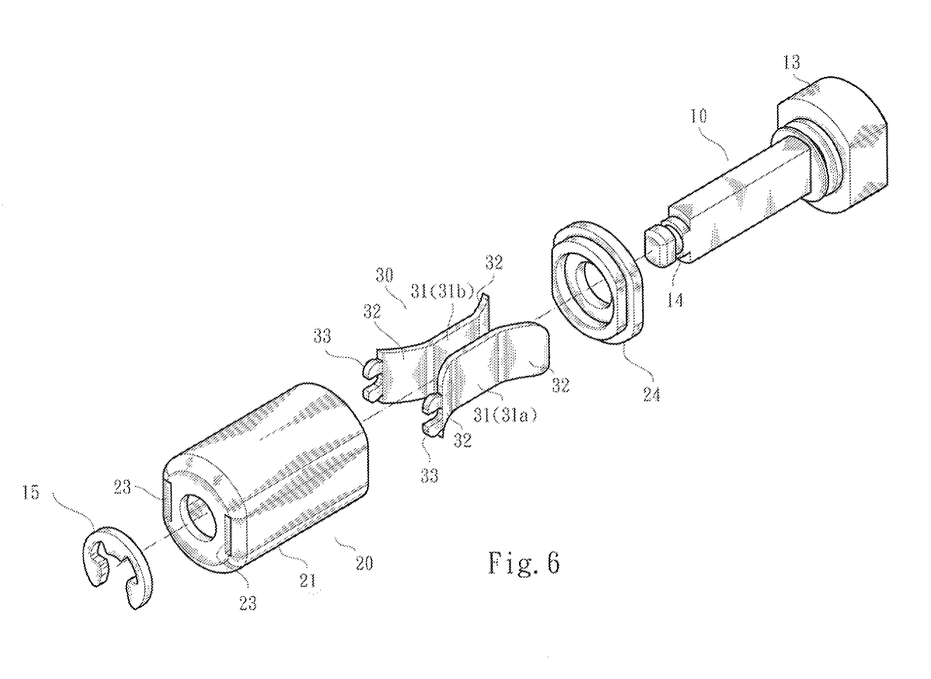

Referring to FIG. 6, a modified embodiment is shown. The shaft body 10 and the head portion 13 are formed by integral type. The shaft body 10 comprises a tail end provided with a groove 14. When the shaft body 10 is assembled in the cylinder body 20, the groove 14 of the shaft body 10 is pivoted to a snap ring 15 so as to prevent an axial displacement of the shaft body 10. Therefore, a slackness condition of the shaft body 10 and the head portion 13 does not occur when the cover 24 of the cylinder body 20 is cooperated to limit the shaft body 10 and the head portion 13.

Representatively speaking, with the conditions of operative rotational and locating functions of the rotary shaft location structure, the invention provides the considerations and advantages as follows, compared with conventional skills.

Firstly, the structure of the rotary shaft and components (e.g., the cylinder body 20, the load portion 31 and the arm portion 32 of the elastic device 30, etc.) connected therewith, in cooperation with the first and second plane region 11a and 11b of the shaft body 10 and to generate an elastic movement type, have been redesigned and reconsidered, providing compact structural design and varied usage pattern to be distinguished from conventional skills. Moreover, it is obviously that the fitting structure of the shaft body 10, the cylinder body 20 and the carrier 30 is different from the structural pattern applied with multiple washers and friction plates in conventional skills. Besides, undesirable conditions, such as abrasion and improper locating effects often occurred in the embedded structure of the locating flange, the convex pockets or the concavo-convex locating portions of the related components in conventional skills after an operation period, can be greatly improved accordingly.

Secondly, with the fitting structure of the first plane region 11a and the second plane region 11b of the shaft body 10, the arc region 12 of the shaft body 10, the cylinder body 20 and the carrier 30 (e.g., the load portion 31 and the arm portion 32), conditions such as the whole structural design and the complicated and time-consuming assembly-fitting process in conventional skills which are applied with multiple washers and friction plates can he improved. Moreover, the condition of impair and limit to the arrangement spaces of the rotary shaft and the electronic apparatus due to the over-length assembled arrangement length of the locating mechanism in the axial direction can be obviously improved.

Thirdly with the fitting structure of the load portion 31 of the elastic devices 30 to normally press to and the shaft body 10 to generate the clamping force, the invention can provide the cover or the display screen of the electronic apparatus with a locating function when being situated at any position or angle between the opened position and the closed position.

Fourthly, compared to the conditions in convent skills such as obtaining the operations with ideal torsion or frictional resistance by regulating the screw nut to pack the washer by the assembling fitter but often resulting in the washer to be deformedly destroyed and the rotary shaft to be formed with unstable rotation or slackness and correspondingly to cause the rotary shaft as a defect product and to increase the manufacturing cost, these improper conditions in the conventional skills can be effectively improved by the aspects of the invention.

Accordingly, the invention effectively provides a rotary shaft location structure featuring of a unique spatial pattern and incomparable advantages and inventiveness, superior to conventional skills.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A rotary shaft location structure, comprising:
a combination of a shaft body and a cylinder body, in which the cylinder body comprises a rigid wall and a chamber defined by the rigid wall and utilized to receive the shaft body, the shaft body comprises at least one arc region and a plane region, at least one elastic device is installed inside the chamber of the cylinder body to thrill a contact condition with the shaft body, and the elastic device and at least one of the arc region and the plane region of the shaft body generate a frictional resistance in response to a movement of the shaft body.

2. The rotary shaft location structure as claimed in claim 1, wherein the shaft body formed by type of a cylindrical body is pivoted to a head portion.

3. The rotary shaft location structure as claimed in claim 1, wherein the arc region and the plane region are formed on a surface of the shaft body.

4. The rotary shaft location structure as claimed in claim 1, wherein the plane region of the shaft body comprises a first plane region and a second plane region.

5. The rotary shaft location structure as claimed in claim 4, wherein the first plane region and the second plane region of the plane, region of the shaft body are configured by type of an interval of 180 degrees.

6. The rotary shaft location structure as claimed in claim 1, wherein the elastic device comprises a load portion and an arm portion.

7. The rotary shaft location structure as claimed in claim 1, wherein the elastic device is an elastic sheet formed by type of a hexagonal-bracket shape comprising one load portion and two arm portions.

8. The rotary shaft location structure as claimed in claim 6, wherein the load portion of the elastic device and the shaft body are formed in a contact state, and the arm portion of the elastic device is supported by the rigid wall of the cylinder body.

9. The rotary shaft location structure as claimed in claim 1, wherein the elastic device comprises at least one end provided with an extended portion which is embedded on the cylinder body.

10. The rotary shaft location structure as claimed in claim 9, wherein the extended portion of the elastic device is formed by type of a claw-shaped object.

11. The rotary shaft location structure as claimed in claim 9, wherein the cylinder body further comprises a slit assembled with the extended portion of the elastic device.

12. The rotary shaft location structure as claimed in claim 7, wherein one of the arm portions of the elastic devices comprises a tail end provided with an extended portion which is embedded on the cylinder body.

13. The rotary shall location structure as claimed in claim 1, wherein the cylinder body further comprises a cover utilized to seal the chamber of the cylinder body.

14. The rotary shaft location structure as claimed in claim 2, wherein the head portion is located outside the cylinder body.

15. The rotary shaft location structure as claimed in claim 1, wherein two elastic devices assembled in the chamber of the cylinder body are utilized to press on the shaft body, respectively.

16. The rotary shaft location structure as claimed in claim 6, wherein two elastic devices assembled in the chamber of the cylinder body are utilized to press on the shaft body, respectively.

17. The rotary shaft location structure as claimed in claim 6, wherein the plane region of the shaft body comprises a first plane region and a second plane region, and two elastic devices assembled in the chamber of the cylinder body are utilized to press on the first plane region and the second plane region of the shaft body, respectively.

18. The rotary shaft location structure as claimed in claim 1, wherein a distance measured from the arc region of the shaft body to a center of the shaft body is greater than a distance measured from the plane region of the shaft body to the center of the shaft body.

19. The rotary shaft location structure as claimed in claim 1, wherein the shaft body and a head portion are formed by integral type.

20. The rotary shaft location structure as claimed in claim 1, wherein the shaft body comprises a tail end provided with a groove.

21. The rotary shaft location structure as claimed in claim 19, wherein the shaft body comprises a tail end provided with a groove.

22. The rotary shaft location structure as claimed in claim 20 or 21, wherein the groove of the shaft body is pivoted to a snap ring.

23. The rotary shaft location structure as claimed in claim 1, wherein the shaft body and the cylinder body are assembled on an electronic apparatus.
